(19) United States
(12) Patent Application Publication
(10) Pub. No.: US 2009/0319318 A1
(43) Pub. Date: Dec. 24, 2009

(54) NOTIFICATION TRANSMISSION OVER A NETWORK BASED ON OBSERVED DATA

(75) Inventors: Santiago Estefania, Sugar Land, TX (US); Travis Allen Johnson, Houston, TX (US); Ronald Leon, Maracaibo (VE); Robert Gregor Villalobos, Maturin (VE); Michael Behounek, Houston, TX (US)

Correspondence Address: SCHWEGMAN, LUNDBERG & WOESSNER, P.A., P.O. BOX 2938, MINNEAPOLIS, MN, 55402, US

(73) Assignee: Halliburton Energy Services, Inc., Houston, TX (US)

(21) Appl. No.: 12/552,201

(22) Filed: Sep. 1, 2009

Related U.S. Application Data
(63) Continuation of application No. 10/930,724, filed on Aug. 31, 2004.

(51) Int. Cl. G06F 19/00

(52) U.S. Cl. 705/7

(57) ABSTRACT

One embodiment includes an apparatus that comprises a storage medium to store a database. The apparatus also includes a port to receive, over a network, data related to a number of observations at a work site based on input into an electronic device. The apparatus includes a processor to store the data into the database, wherein the processor is to output a notification message through the same or a different port and over the network to an account of a supervising party based a metric related to the number of observations.

### TECHNICAL FIELD

The application relates generally to data communications. In particular, the application relates to notification transmission over a network based on observed data.

### BACKGROUND

Workplace safety and environmental pollution prevention are critically important issues across different types of businesses. A number of behavior-based safety programs have been developed to focus on unsafe behaviors. One example of such a program developed over twenty years ago is the Safety Training Observation Program (STOP). The premise of STOP is that workplace injuries can be prevented through observation of one's own activities as well as activities of other workers. STOP requires that workers act by establishing a dialog with the person making an unsafe act and write down on cards the unsafe behavior seen and the corrective and preventive actions taken. Such cards are typically submitted to operational and Health and Safety Environment(???) management of the organization. Those managers manually review all of the different cards received and provide recommendations or institute new procedures across the entire business. There may be a long time delay from the point such observations are generated until actions are taken as consequences of management review.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given reference number in a Figure is associated with the number of the Figure. For example, a network 102 can be located in FIG. 1. However, reference numbers are the same for those elements that are the same across different Figures. In the drawings:

FIG. 1 illustrates a network for notification transmission of observations, according to some embodiments of the invention.

FIG. 2 illustrates a system for notification transmission, according to some embodiments of the invention.

FIGS. 3A-3B illustrate computer devices for notification transmission over a network, according to some embodiments of the invention.

FIG. 4 illustrates a flow diagram for transmitting a notification to a person (such as a supervising party) regarding a number of observations, according to some embodiments of the invention.

FIG. 5 illustrates a flow diagram for notifying one business entity regarding observations at work sites for other business entities, according to some embodiments of the invention.

FIG. 6 illustrates a flow diagram for notifying a supervising party of the reporting of observations at work sites by persons, according to some embodiments of the invention.

FIGS. 7A-7B illustrate Graphical User Interface (GUI) screens for inputting data related to an observation, according to some embodiments of the invention.

FIG. 7C illustrates a GUI screen that displays an icon that may be called upon or pops-up for a notification related to observations, according to some embodiments of the invention.

FIGS. 7D-7G illustrate GUI screens that display the number of observations based on different selection criteria, according to some embodiments of the invention.

FIGS. 7H-7J illustrate GUI screens that display a more detailed description of the observation, according to some embodiments of the invention.

FIG. 7K illustrates a GUI screen that displays reactions of people for given time periods, according to some embodiments of the invention.

FIG. 7L illustrates a GUI screen that displays a more detailed description of particular persons that may input an observation into the system, according to some embodiments of the invention.

FIG. 7M illustrates a GUI screen that displays a more detailed description of particular observations that a given person may input into the system, according to some embodiments of the invention.

### DETAILED DESCRIPTION

Methods, apparatus and systems for notification transmission over a network based on observed data are described. In the following description, numerous specific details are set forth. However, it is understood that embodiments of the invention may be practiced without these specific details. In other instances, well-known circuits, structures and techniques have not been shown in detail in order not to obscure the understanding of this description.

Embodiments of the invention allow for the electronic reporting and statistical and/or heuristic analysis of observations of behavior that is unsafe and non-environmentally friendly (performed by personnel at different work sites). In some embodiments, observations are defined to include acts of recognizing or noting of an occurrence. The observations may be of unsafe or non-environmentally friendly activity by different persons. With regard to observations of unsafe activity, an example of such activity may include the failure to wear personal protective equipment for different parts of the body (e.g., the head, eyes, face, ears, respiratory system, hands, arms, trunk, feet, legs, etc.). For example, the observation may relate to the lack of wearing of proper eye wear. Another example of the activity that may be observed includes the reactions of people. In particular, the reactions of people may indicate that unsafe or non-environmentally friendly activity may have been occurring. Examples of such reactions may include the adjusting of equipment, changing positions, rearranging a job, stopping a job, attaching grounds, lockouts, etc.

In some embodiments, observed activity may include the positions of people. Examples of such positions may include being caught in, on or between objects, falling, contacting temperature extremes, contacting electric current, inhaling, absorbing, overexertion, repetitive movements, etc. In some embodiments, observed activity may relate to the tools and equipments. For example, a person may be using the wrong tool for the job, using the tool incorrectly or in an unsafe condition. In some embodiments, observed activity may relate to procedures and orderliness. For example, the procedures or orderliness may be inadequate, not understood or not followed.

With regard to non-environmentally friendly observations, examples of such activity may include the filling or transferring of liquids or solids improperly, the storing of solid or liquid materials or equipment incorrectly, or labeling improperly the products and materials or the lack of proper identification of such products and materials. Other examples may include washing and cleaning of tools and equipment using inappropriate products, using inappropriate procedures to clean tools and equipment, wasting of products or materials, or using inappropriately or not using dust control systems. Still further examples may include managing inappropriately the waste materials after operation activities, storing waste (toxic and non-toxic) improperly or maintaining inappropriately or not maintaining the oil/water separate and/or drains.

Persons may input the data related to such observations into any of a number of different electronic devices (such as desktop computers, notebook computers, Personal Digital Assistants (PDAs), etc.). Such devices may transmit this data over a network (such as the World Wide Web) to a centralized server for storage therein. Embodiments may allow for the graphical display of these observations based on a number of different categories, such as geographic location, product service line, client, time period, etc. Further, embodiments may allow for the sorting of the observations for each of the different personnel and rank such personnel according to the number of observations reported.

In some embodiments, notifications are transmitted over a network to an electronic device that a supervising party (such as managers for a given work site, group of persons, etc.) is using to access their account. For example, some embodiments may allow for transmission of notification messages over a network to an account to the manager of a work site based on observations of activity made at such site. Accordingly, the notification messages may be transmitted to a particular electronic device that this person is using for accessing their account. The transmission of these notification messages may be based on any of a number of different criteria related to the observations stored in the centralized server. In some embodiments, the different accesses into the database of observations made by a supervising party may determine the transmission of these notification messages. For example, if the supervising party monitors a given type of observation (such as the lacking of wearing of certain type of safety equipment), a notification may be transmitted to the account of the supervising party if the number of such observations exceeds a threshold. Alternatively or in addition, if the supervising party monitors a particular work site, a given geographic region and/or a given type of product service line, a notification may be transmitted to the account of the supervising party if the number of observations at such work site or geographic region or for such product service line exceeds a threshold.

Moreover, notifications may be based on the activity of other persons. For example, assume that work site A is similar to work site B. If the manager of work site A is monitoring a particular category of observation, work site and/or product service line, a notification may be transmitted to the account of the manager of work site B based on such monitoring by the manager of work site A. In some embodiments, the criteria for transmitting the notifications to a person may be user-configurable. Furthermore, the notification may be any of a number of different forms, including a pop-up icon, an email message, etc. Because such data is stored in a centralized server, in some embodiments, notifications may be based on observations among different independent business entities. Accordingly, a manager at company C may be notified based on observations that occur at a work site for company D. Such notifications may, therefore, allow managers to identify potential causes and take preventive actions, thereby avoiding injuries or costly accidents that may negatively impact the operations at the work site.

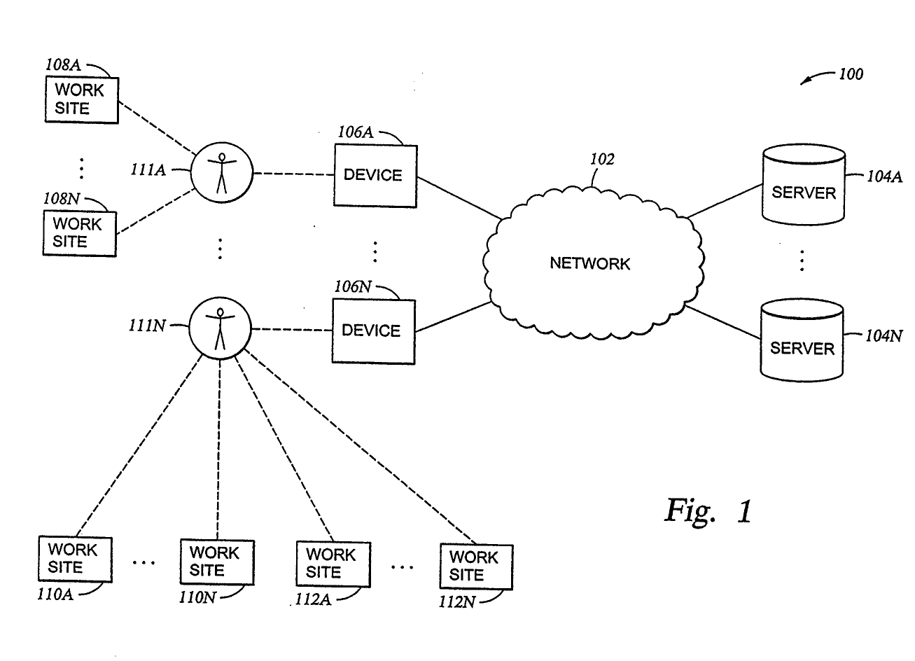

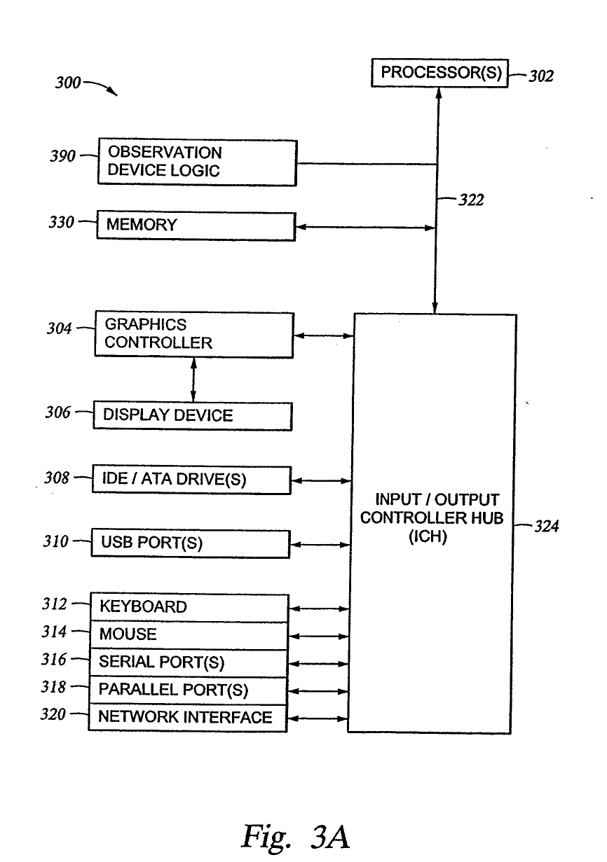

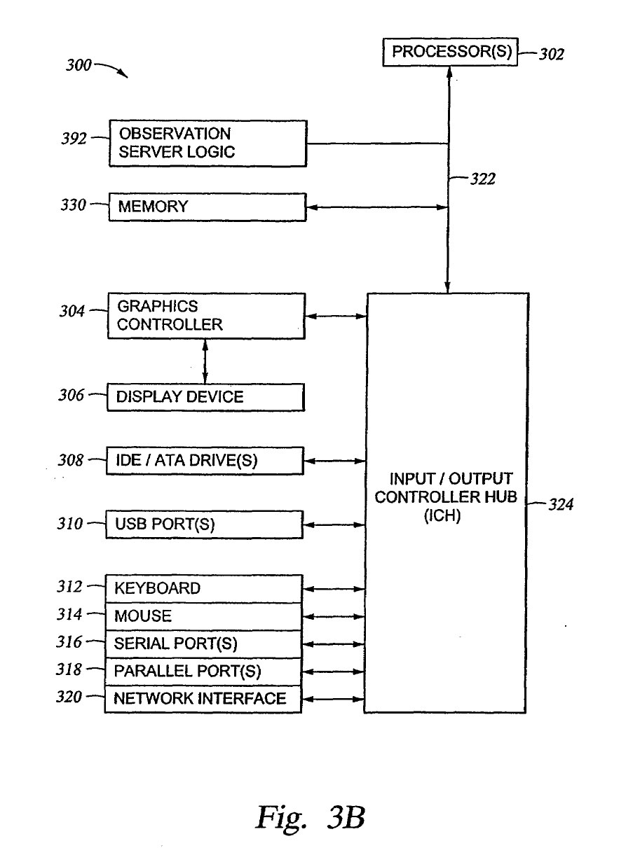

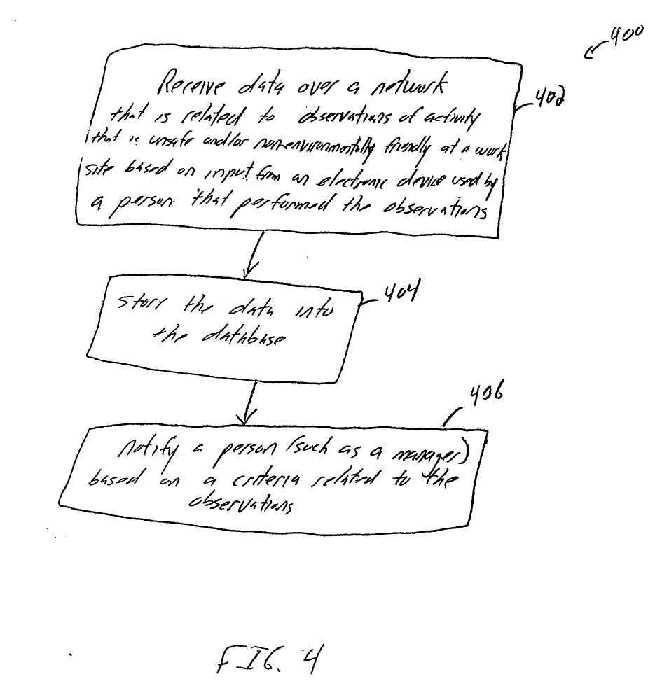

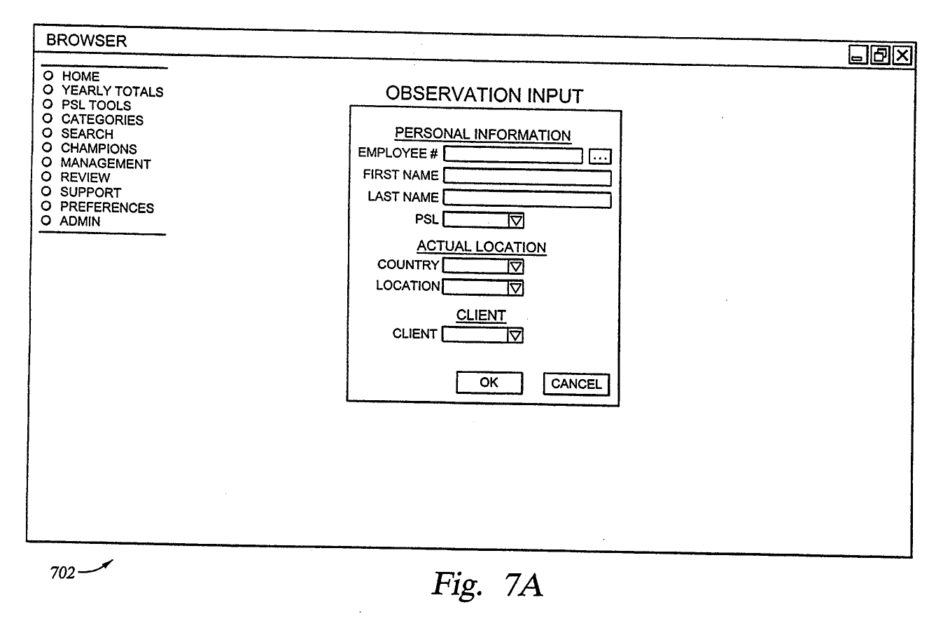

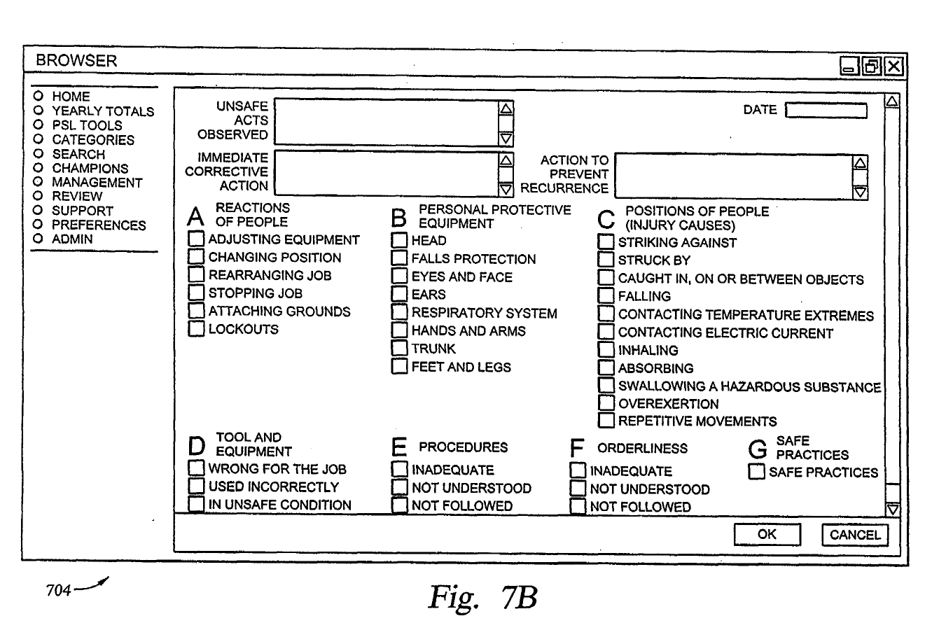

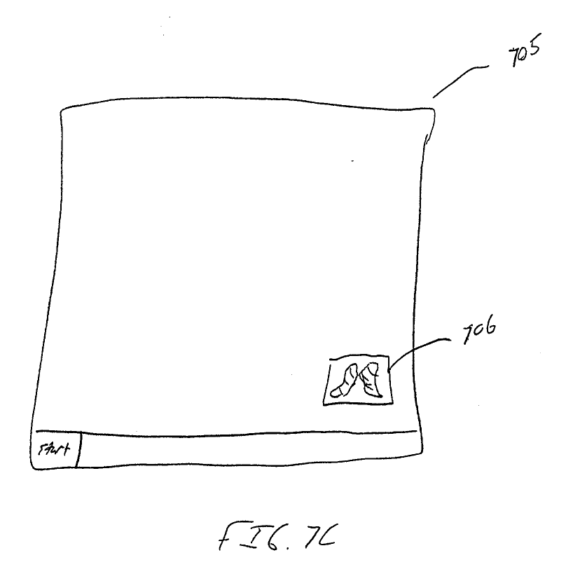

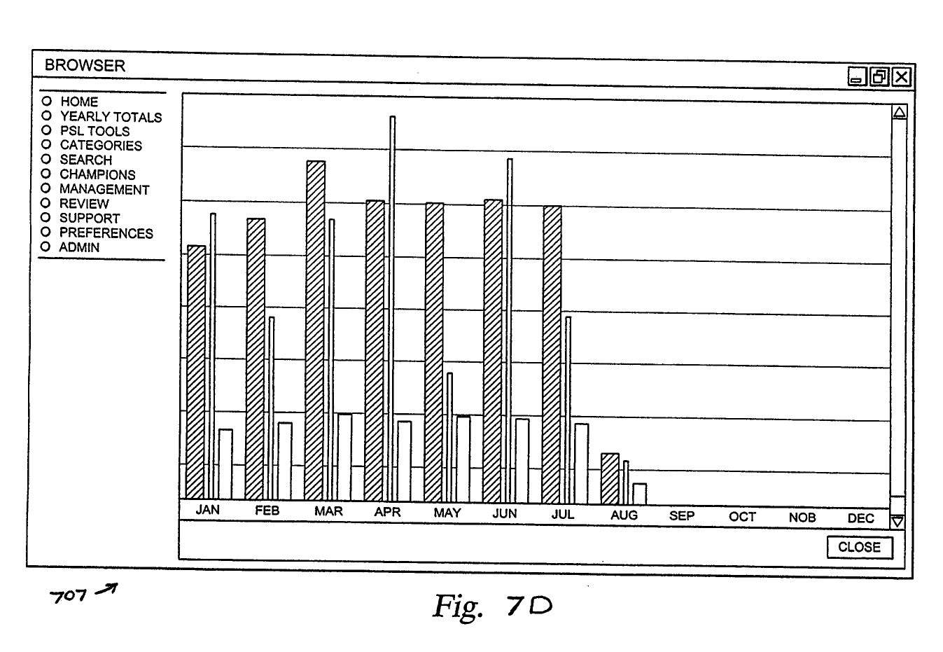

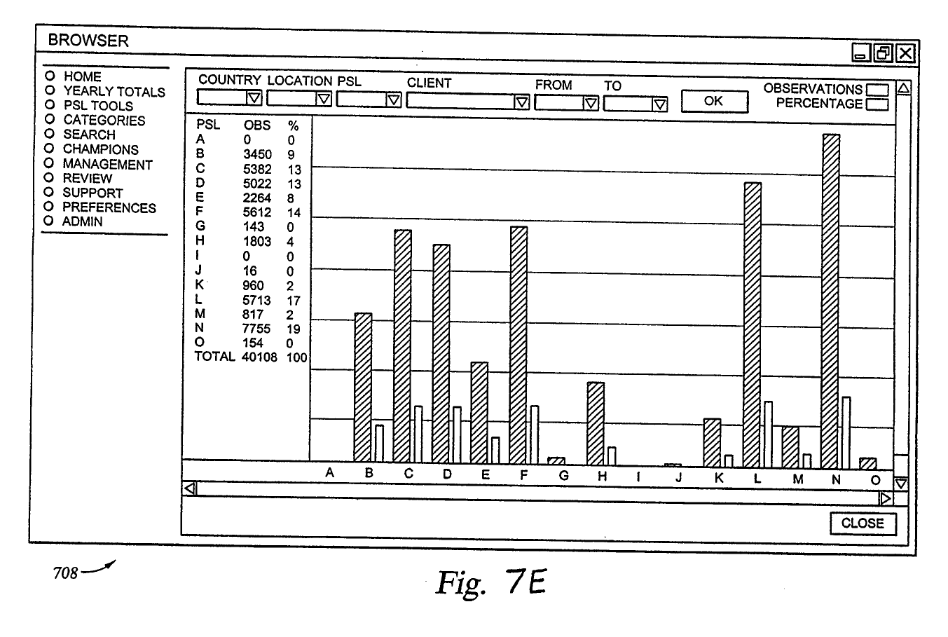

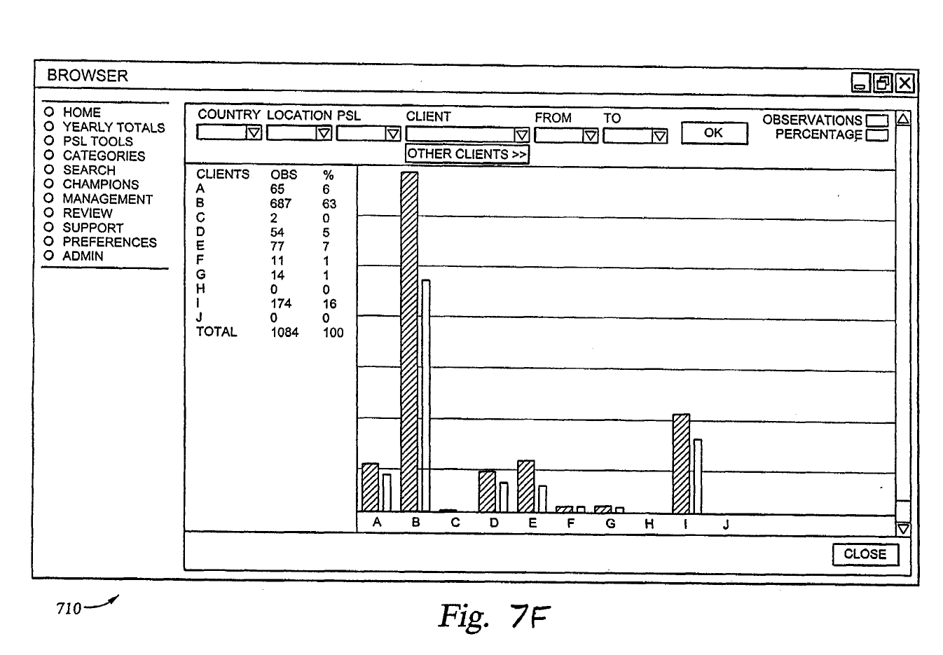

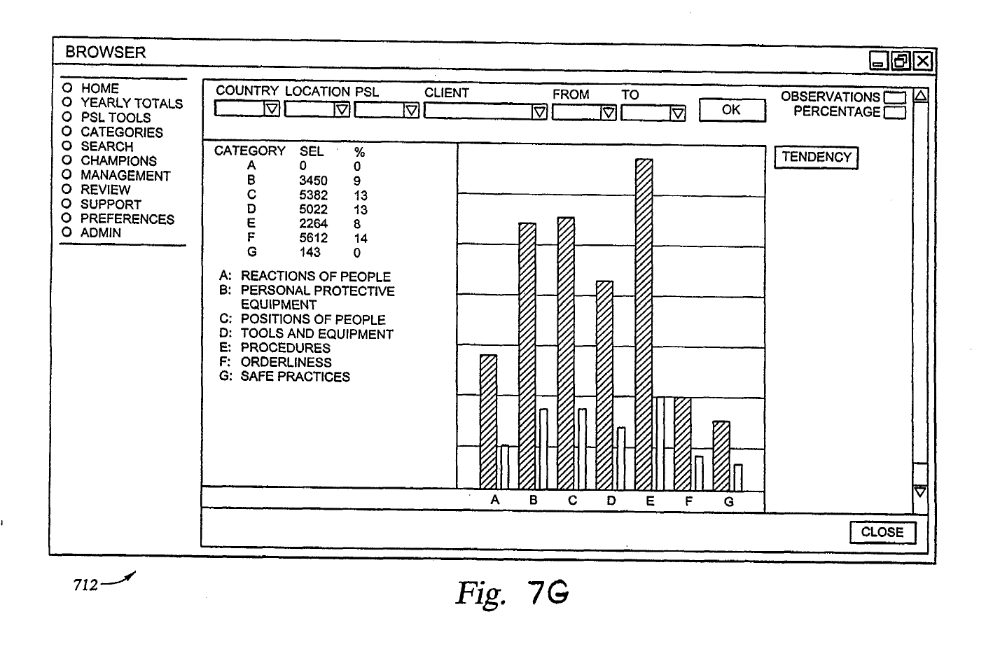

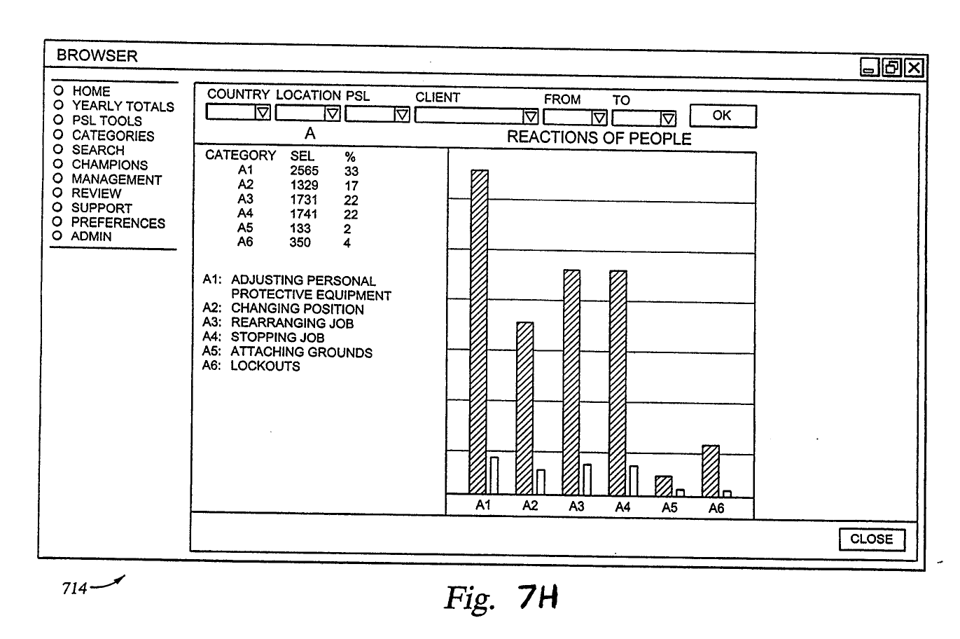

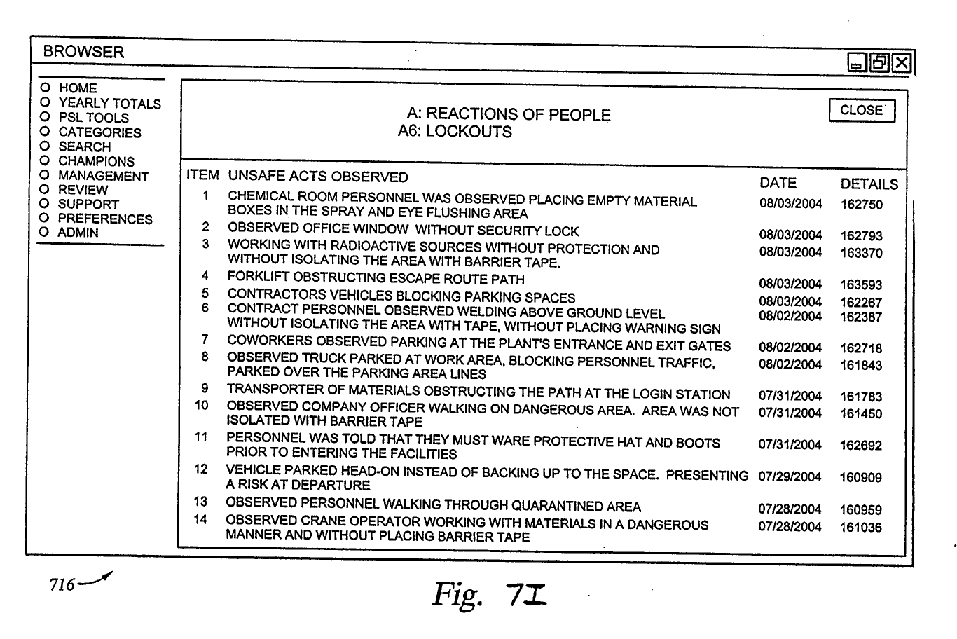

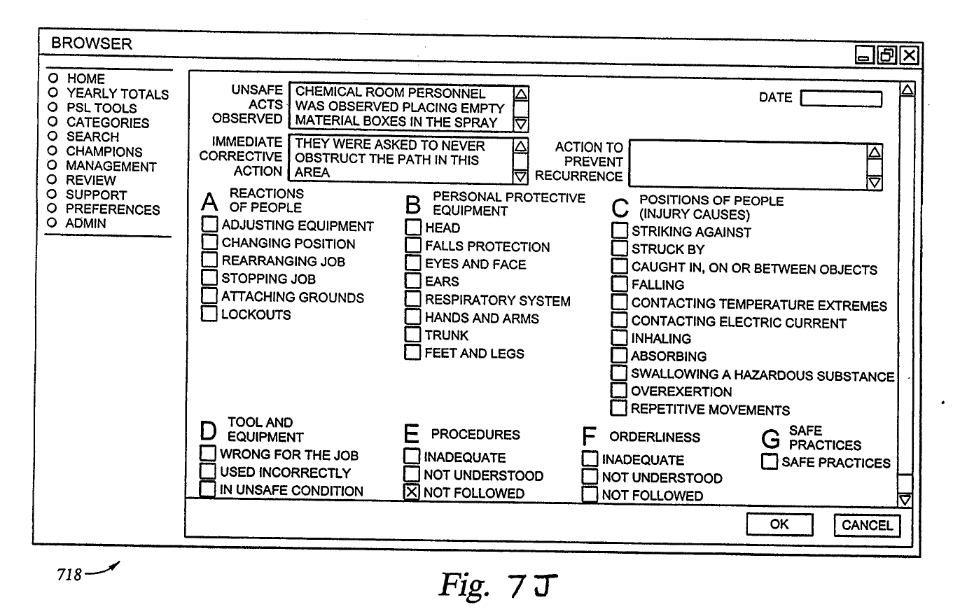

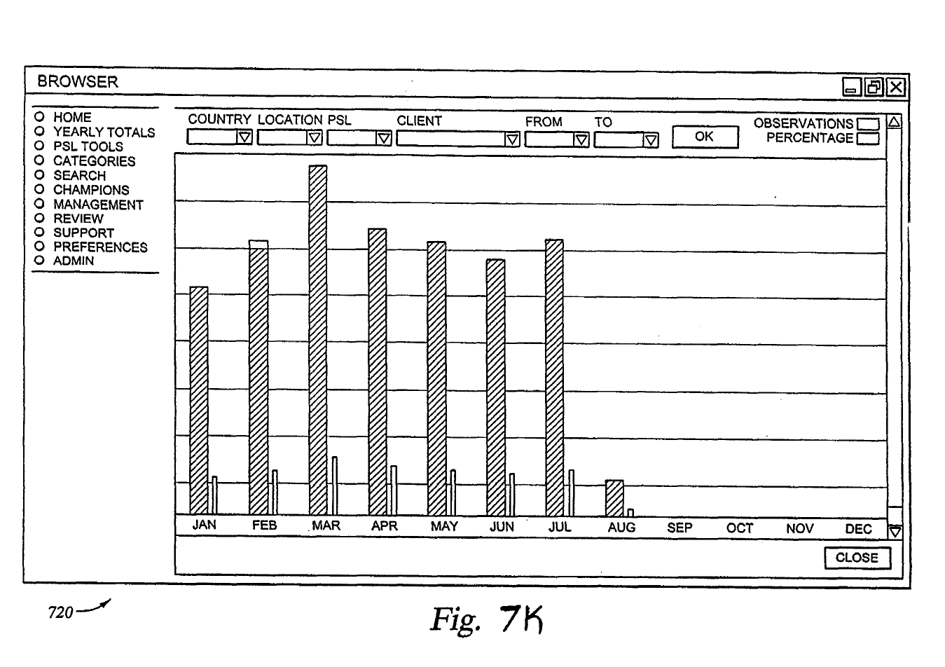

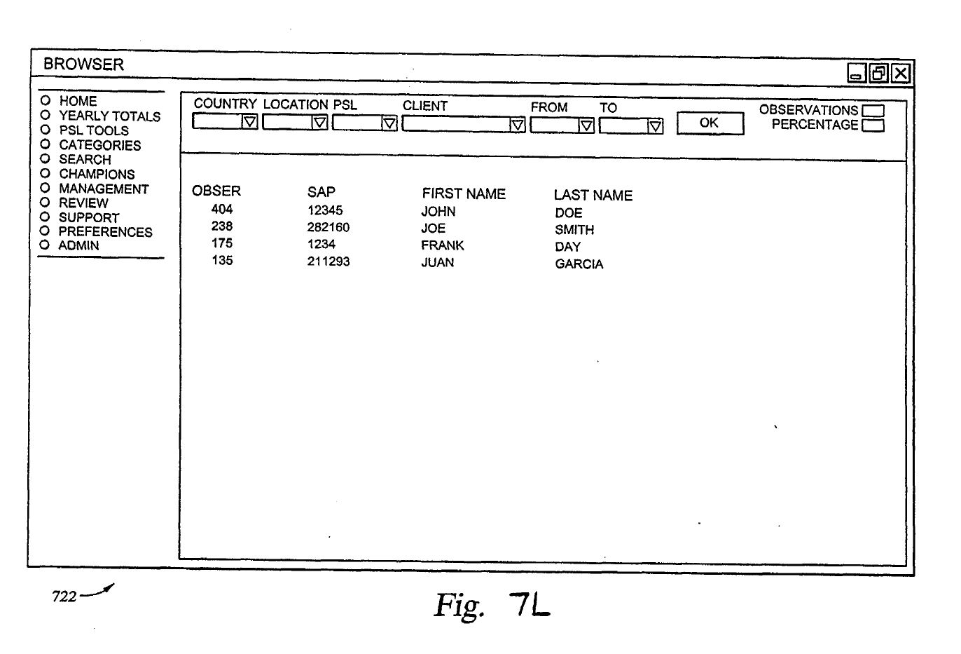

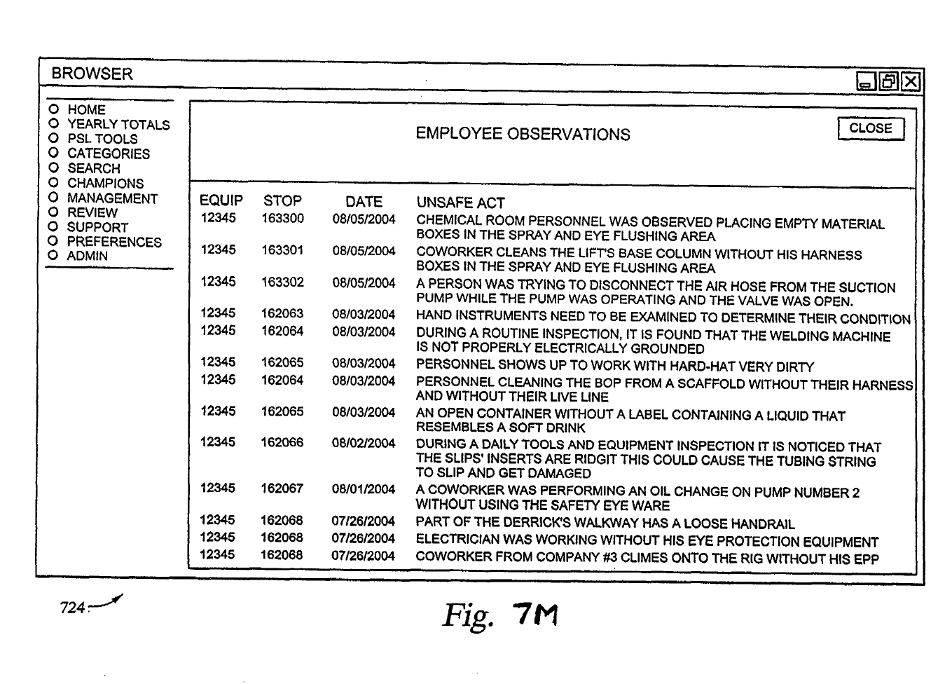

FIGS. 1 and 3A-3B illustrate a system and apparatus for notification transmission over a network based on observed data, respectively, according to some embodiments of the invention. FIGS. 4-6 illustrate a number of flow diagrams for the operations for notification transmission over a network based on observed data, according to some embodiments of the invention. FIGS. 7A-7M illustrate a number of Graphical User Interface (GUI) screens that may be used for displaying and inputting data related to the observations and notification thereof, according to some embodiments of the invention. The descriptions of the GUI screens are interspersed, where appropriate, throughout the description of the FIGS. 1-6. Moreover, the GUI screens shown in FIG. 7A-7O are specific for observations of unsafe activity. However, such GUI screens are by way of example and not by way of limitation, as similar GUI screen may be used for observations that are non-environmentally friendly.

FIG. 1 illustrates a network for notification transmission of observations, according to some embodiments of the invention. In particular, FIG. 1 illustrates electronic devices 106A-106N and servers 104A-104N, which are coupled together through a network 102. The electronic devices 106A-106N may include one to any number of such devices coupled to the network 102. Similarly, the servers 104A-104N may include one to any number of such servers coupled to the network 102. While different embodiments may have different types of interfaces for the electronic devices 106A-106N and the servers 104A-104N, in some embodiments, the interface may be Web-based, wherein the network 102 is the World Wide Web (WWW). The network 102 may be of different types, such as a local area network (LAN), other types of a wide area network (WAN), etc.

Further, the network 102 may be a combination of different networks that provide communication among the servers 104A-104N and the electronic devices 106A-106N. The electronic devices 106 and the servers 104 may communicate with the network 102 through wired and/or wireless communication. Moreover, to allow for increased security regarding the communications between the electronic devices 106 and the servers 104, virtual private networks (VPNs) within the network 102 may be established between a given electronic device 106 and a given server 104.

FIG. 1 also illustrates a number of work sites (work sites 108A-108N, work sites 110A-110N and work sites 112A-112N) and a number of persons (persons 111A-111N). The persons 111A-111N may observe activity that is considered unsafe and/or non-environmentally friendly at the work sites 108A-108N, the work sites 110A-110N and the work sites 112A-112N. The persons 111A-111N may input data related to such observations into one of the electronic devices 106A-106N. Software executing on the electronic devices 106A-106N may transmit such data for storage into a database in one of the servers 104A-104N. FIGS. 7A-7B illustrate Graphical User Interface (GUI) screens for inputting data related to an observation, according to some embodiments of the invention. FIG. 7A illustrates a GUI screen 702 for inputting data related to the person that observed the observation (e.g., employee identification, name, location that the observation was observed, etc.). FIG. 7B illustrates a GUI screen 704 for inputting data related to the observation (reactions of people, personal protective equipment, etc.).

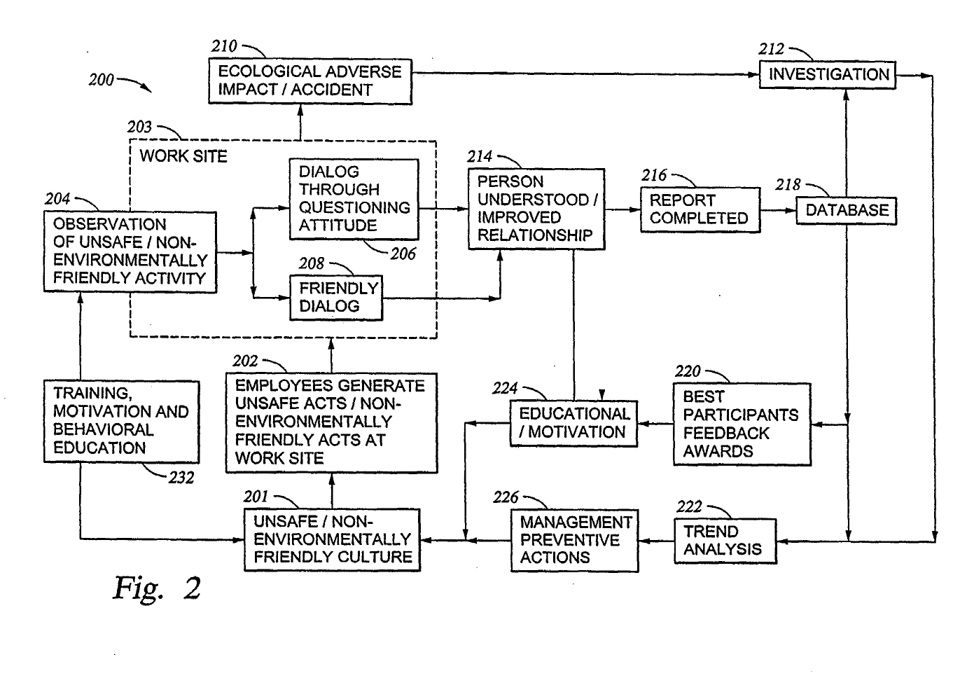

FIG. 2 illustrates a system for notification transmission, according to some embodiments of the invention. In particular, FIG. 2 illustrates a system 200 that includes a work site 203 and a database 218 for storage of data related to observations of unsafe or non-environmentally friendly activity made at the work site 203. As shown, the system 200 includes a number of blocks that illustrate actions based on the observations made at the work site 203. A block 201 includes a unsafe/non-environmentally friendly culture. Such culture contributes to unsafe/non-environmentally friendly activity by employees (which is illustrated by the input into block 202). A block 204 includes the observation of the unsafe/non-environmentally friendly activity. Such observation may be made by other employees, supervisors, managers, etc. As shown in a block 206 and a block 208, there may be dialog between the person making the observation (i.e., the observer) and the person that performed the activity. Such dialog may question the attitude of the person performing the activity if the person making the observation is the supervisor or manager. Alternatively or in addition, the dialog may be friendly, wherein the person making the observation informs the person who performed the activity that the observation was made.

The output of the blocks 206 and 208 may lead to a block 214, wherein there is an understanding by the person that performed the unsafe/non-environmentally friendly of such activity. Moreover, such dialog may lead to an improved relationship between the observer and the person being observed. The output of the block 214 may result in an input into the block 216, which includes the completion of a report regarding the observation of the activity. Additionally, the output of the block 214 may result in an input into the block 224, which includes education and motivation of the persons that performed the activity. As described in more detail below, the completion of the report may be performed by inputting data related thereto into an electronic device by the observer. Such data is inputted into the database 218, which may be over a network, as shown in FIG. 1.

Regardless of the number of observations made, a block 210 illustrates that an ecologically adverse impact or accident may occur at the work site 203. The output of the block 210 is input into a block 212, which includes an investigation of the ecologically adverse impact or accident. As shown, data related to the observations stored in the database 218 may be used as input into the investigation. A result of the investigation is input into a block 222, which includes a trend analysis regarding the ecologically adverse impact/accidents as well. Moreover, the trend analysis may include data regarding the observations from the database 218. The result of the trend analysis may include preventive actions performed by management (block 226). Such actions may include new procedures related to the activity/accidents, etc. The result of the management preventive actions are input into the unsafe/non-environmentally friendly culture in order to change such culture.

Best participants/feedback awards may be made to those persons that are most involved in the reporting of observations (block 220). Such awards may be based on the data stored in the database 218. The result of these awards may include education/motivation of workers (as shown by the input into the block 224). The result of the education/motivation may be input into the unsafe/non-environmentally friendly culture in order to change such culture. A block 232 illustrates training, motivation and behavioral education, which may be input into the observations (block 204) and the culture (201). This training, motivation and behavioral education may allow for more observations at block 204 and a change in the culture at block 201. The reporting and storage of these observations as well as the transmission of data related thereto to supervising parties are described in more detail below.

FIGS. 3A-3B illustrate computer devices for notification transmission over a network, according to some embodiments of the invention. In particular, FIG. 3A and FIG. 3B illustrate, respectively, the electronic devices 106 and the servers 104, according to some embodiments of the invention. As shown, FIG. 3A includes an observation device logic 390, while FIG. 3B includes an observation server logic 392.

In some embodiments, the observation server logic 392 and the observation device logic 390 may be instructions executing within the processor(s) 302. Therefore, the observation server logic 392 and the observation device logic 390 may be stored in a machine-readable medium that are a set of instructions (e.g., software) embodying any one, or all, of the methodologies described herein. For example, the observation server logic 392 and the observation device logic 390 may reside, completely or at least partially, within the memory 330, the processor(s) 302, one of the IDE/ATA drive(s) 308, etc. In some embodiments, the observation server logic 392 and the observation device logic 390 may be hardware logic. In an embodiment, the observation server logic 392 and the observation device logic 390 may be a combination of software, firmware and/or hardware.

As illustrated in FIGS. 3A-3B, a computer device 300 also comprises processor(s) 302, a memory 330, a processor bus 322, and an input/output controller hub (ICH) 324. The processor(s) 302, the memory 330, and the ICH 324 are coupled to the processor bus 322. The processor(s) 302 may comprise any suitable processor architecture. The computer device 300 may comprise one, two, three, or more processors, any of which may execute a set of instructions in accordance with embodiments of the invention.

The memory 330 stores data and/or instructions, and may comprise any suitable memory, such as a random access memory (RAM). For example, the memory 330 may be a Static RAM (SRAM), a Synchronous Dynamic RAM (SDRAM), DRAM, a double data rate (DDR) Synchronous Dynamic RAM (SDRAM), etc. A graphics controller 304 controls the display of information on a display device 306, according to an embodiment of the invention.

The ICH 324 provides an interface to Input/Output (I/O) devices or peripheral components for the computer device 300. The ICH 324 may comprise any suitable interface controller to provide for any suitable communication link to the processor(s) 302, the memory 330 and/or to any suitable device or component in communication with the ICH 324. In some embodiments of the invention, the ICH 324 provides suitable arbitration and buffering for each interface.

In an embodiment, the ICH 324 provides an interface to one or more suitable Integrated Drive Electronics (IDE)/Advanced Technology Attachment (ATA) drive(s) 308, such as different types of storage mediums (e.g., a hard disk drive (HDD) or compact disc read only memory (CD ROM) drive) or to suitable universal serial bus (USB) devices through one or more USB ports 310. In an embodiment, the ICH 324 also provides an interface to a keyboard 312, a mouse 314, one or more suitable devices through one or more parallel ports 318 (e.g., a printer), and one or more suitable devices through one or more serial ports 316. In some embodiments, a database may be stored in one or more of the IDE/ATA drives 308, the memory 330, a cache internal to the processor(s) 302, etc. In some embodiments, the ICH 324 also provides a port or a network interface 320 through which the computer device 300 can communicate with other computers and/or devices. The port 320 may be used to transmit and receive data related to observations related to activity that is unsafe and/or non-environmentally friendly or notifications thereof.

FIG. 4 illustrates a flow diagram for transmitting a notification to a person (such as a supervising party) regarding a number of observations, according to some embodiments of the invention. In particular, FIG. 4 illustrates a flow diagram 400 that includes the operations for notifying a person (such as a supervising party) based on a criteria for observations (such as observations of unsafe and/or non-environmentally activity at a work site) that are electronically reported by persons that made the observations. Such data may be input into one of the electronic devices 106 by a person that observes such observations at a work site. In some embodiments, software that allows for a Web-based interface may be executing on the electronic devices 106 to allow such persons to input data. Accordingly, such data may be transmitted over a network, such as the World Wide Web, to a centralized server for storage into a database. Therefore, some embodiments allow for data related to observations across any of a number of different work sites. For example data related to the different observations may be received for different geographic locations, different product service lines and/or different clients.

In block 402, data is received over a network that is related to an observation of unsafe activity or an observation of activity that are non-environmentally friendly at a work site based on input into an electronic device by a person that performed the observation. With reference to the embodiments of FIGS. 1 and 3A, a person may input the data related to the observation into one of the electronic devices 106. The observation device logic 390 may receive and forward such data over the network interface 320 and through the network 102 to one of the servers 104. With reference to the embodiments of FIGS. 1 and 3B, the observation server logic 392 may receive the data over the network interface 320. Control continues at block 404.

In block 404, the data is stored in a database. With reference to the embodiment of FIG. 3B, the observation server logic 392 may store the database in one of the IDE/ATA drive(s) 308. In some embodiments, the database may include a number of different data structures for storage of the data. For example, the database may include an observation table that stores the received observations therein. The database may also include a table for storage of data related to the observer. For example, this table may include an entry for the different employees in a given business entity that may transmit observations over the network. Such an entry may include the employee identification, name of employee, the product service line on which the employee is working on, the geographic location of the work site where the employee works and the client for which the employee works. In some embodiments, when the data is received over the network, the observation server logic 392 may verify that the employee has an entry in this table and that the data therein is accurate. Accordingly, if the employee is working on a different product service line, in a different geographic location and/or on a different client (relative to a previous time period when the table was updated), such entry may be updated. In some embodiments, the data for different business entities and/or groups within a business entity may be separated into different databases. Such databases may be stored on a same server or a number of different servers. Control continues at block 406.

In block 406, a person (such as a manager) is notified based on a criteria related to the observations and/or their job profile attributes. With reference to the embodiments of FIGS. 1 and 3B, the observation server logic 392 may notify this person. The observation server logic 392 may transmit a notification message through the network interface 320 and over the network 102 to the electronic device 106 to which the person is currently logged into using their account.

In some embodiments, the criteria for notification may based on the accesses to the observations stored in the database by the person being notified. For example, if the manager monitors a given type of observation (such as not wearing safety goggles), a notification may be transmitted to the account of the manager if the number of such observations exceeds a threshold. If the manager monitors a particular work site or a given type of product service line, a notification may be transmitted to the account of the manager if the number of observations at such work site or for such product service line exceeds a threshold. In some embodiments, a notification may be transmitted to the account of a manager based on the geographic region or other related profile attributes for which they are responsible. Therefore, if observations of different types exceed a threshold at one of the work sites in that geographic region, the manager may be notified.

In some embodiments, criteria for notification may be based on the manager is currently working on (e.g., a particular project). The manager may be notified based on the observations stored in the database. To illustrate, a manager may be planning a new set of work instructions. Based on such activity, a notification may be transmitted based on a configurable threshold.

In some embodiments, the criteria for notifications may be based on the activity of other persons. If the manager of work site A is monitoring a particular observation, work site and/or product service line, a notification may be transmitted to the account of the manager of work site B based on such monitoring by the manager of work site A. In some embodiments, the criteria may be user-configurable. Accordingly, the person receiving the notifications may customize what may trigger the notifications.

In some embodiments, a search of the stored observations may be initiated based on a set of criteria configured by the manager. Such criteria may include relevant issues that they need to be aware of based on relevant stored observations. For example, a person may be ready to commence a task. Such person may call for a search of acute areas to take into account based on a defined, selectable criteria. Notification of potentially relevant items may be displayed based on a logic or analysis of the stored observations.

Such a notification message may cause a pop-up icon to be displayed on the display of this electronic device 106. FIG. 7C illustrates a GUI screen that display a pop-up icon for a notification related to observations, according to some embodiments of the invention. In particular, FIG. 7C illustrates a GUI screen 705 that includes a pop-up icon 706 that is displayed on an electronic device in response to a notification message being transmitted thereto. The person may select the icon, which may cause the downloading of a Web page for display. The Web page may include data related to particular types of observations for different geographic locations, work sites, product service lines, etc. Such a Web page may also include statistical and/or heuristic analysis of observations. In some embodiments, the data may be proposed solutions that the manager may implement to preclude the unsafe or non-environmentally friendly activity. For example, solutions may include additional training, different procedures, etc. In some embodiments, the activity on a person's account may be passively monitored and based on certain criteria, the person may be notified of relevant observations based on the given area. In some embodiments, such solutions may be stored in the database of the centralized server. Such solutions may be based on prior or monitored current activities of managers notified of similar observations.

Alternatively or in addition, the notification message may cause the transmission of an email message to the email account of such person. The email message may include data related to the observations and/or the statistical and/or heuristic analysis of the observations. The email message may also include a link to a Web page as described above.

A number of different GUI screens that a person may view in response to selecting the pop-up icon or a link in the email message are now described. FIGS. 7D-7G illustrate GUI screens that display the number of observations based on different selection criteria, according to some embodiments of the invention. In particular, FIG. 7D illustrates a GUI screen 707 that displays the number of observations for the different months for the year 2004, the number of persons that have made observations and the number of observations for the most active observer. For example, for January 2004, 4833 observations were made, 1281 persons made observations and the number of observations for the person that inputted the most observations was 75. FIG. 7E illustrates a GUI screen 708 that displays the number of observations for particular product service lines for a given time period. For example, the number of observations for the product service line L&P is 5382 (13% relative to all of the other product service lines).

FIG. 7F illustrates a GUI screen 710 that displays the number of observations for the year 2004 across a number of different clients. For example, the number of observations for the client BP is 687 (63% relative to all of the other clients). FIG. 7G illustrates a GUI screen 712 that displays the number of observations for given categories of observations (e.g., personal protective equipment) for the year 2004. For example, the number of observations for the observation type B (personal protective equipment) is 14795 (20% relative to all of the other categories).

Moreover, additional data may be transmitted over the network based on a request for the user reviewing the data received on the electronic device 106. For example, FIGS. 7H-7J illustrate GUI screens that display a more detailed description of the observation, according to some embodiments of the invention. Returning to FIG. 7G, in operation, the user (e.g., the manager) may select (e.g., double click) a bar on the graph, which is representative of all of the different observations of a given category. This may cause a request to be transmitted over the network 102 for the detailed entries of all of the observations of that given category. The observation server logic 392 may return the data shown in a GUI screen 714 of FIG. 7H. Furthermore, the user may select a particular entry on the GUI screen 714 (e.g., the A6 column). This may cause a request to be transmitted over the network 102 for that particular entry. The observation server logic 392 may return the data shown in a GUI screen 716 of FIG. 7I. As shown, the observations for the subcategory “A6—Lockouts” are displayed. The user may select a particular entry on the GUI screen 716 (e.g., the first entry). This may cause a request to be transmitted over the network 102 for that particular entry. The observation server logic 392 may return the data shown in a GUI screen 718 of FIG. 7J. As show, the particular observation is displayed.

A person may have only observed a reaction to the person entering a given area. Such reaction may not have been an unsafe or non-environmentally friendly activity. In some embodiments, the person may enter data related to such reactions. FIG. 7K illustrates a GUI screen that displays reactions of people for given time periods, according to some embodiments of the invention. In particular, FIG. 7K illustrates a GUI screen 720 that displays the number of reactions inputted into the system for the year 2004 across the different months. Similar to the observations of unsafe activity in the GUI screens described above, further GUI screens may be displayed for particular types of reactions.

Additionally, the data displayed to the person that selected the pop-up icon/link in the email message may relate to employees and the number of observations such employees have made. For example, FIG. 7L illustrates a GUI screen that displays a more detailed description of particular persons that may input an observation into the system, according to some embodiments of the invention. FIG. 7M illustrates a GUI screen that displays a more detailed description of particular observations that a given person may input into the system, according to some embodiments of the invention.

In particular, FIG. 7L illustrates a GUI screen 722 that displays the number of observations for a given employee. The user may select one of the employees in the GUI screen 722 to display the particular observations by that employee. The observation server logic 392 may return the data shown in a GUI screen 724 of FIG. 7M, which may be displayed as shown. Additionally, the user may select one of the observations in the GUI screen 724 of FIG. 7M to display more details about a particular observation. The observation server logic 392 may return the data shown in the GUI screen 718 of FIG. 7J (described above). Therefore, as described, the GUI screens displayed to the person may allow such person to select parts of such GUI screen to view additional GUI screens.

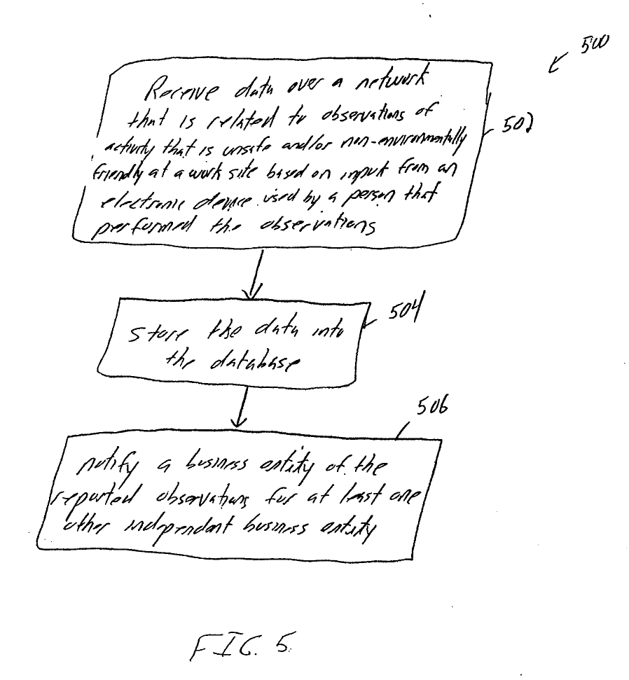

In some embodiments, the system may perform the operations described above for a number of different independent business entities. The data for the observations for one business entity may be of interest to the other business entities. Because the system includes a centralized database for the different business entities, such data may be shared among such entities. Accordingly, notifications may be based on the observations from other business entities. Such operations are now described. In particular, FIG. 5 illustrates a flow diagram for notifying one business entity regarding observations at work sites for other business entities, according to some embodiments of the invention.

In block 502, data is received over a network that is related to observations of activity that is unsafe and/or non-environmentally friendly at a work site based on input from an electronic device used by a person that performed the observation. With reference to the embodiments of FIGS. 1 and 3A, a person may input the data related to the observation into one of the electronic devices 106. The observation device logic 390 may receive and forward such data over the network interface 320 and through the network 102 to one of the servers 104. With reference to the embodiments of FIGS. 1 and 3B, the observation server logic 392 may receive the data over the network interface 320. Control continues at block 504.

In block 504, the data is stored in a database. With reference to the embodiment of FIG. 3B, the observation server logic 392 may store the database in one of the IDE/ATA drive(s) 308 (as described above). Control continues at block 506.

In block 506, a business entity is notified of the reported observations for at least one other independent business entity. With reference to the embodiments of FIGS. 1 and 3B, the observation server logic 392 may notify this business entity. For example, the observation server logic 392 may notify one or more managers regarding different observations that are being electronically reported at other business entities. The observation server logic 392 may transmit a notification message through the network interface 320 and over the network 102 to the electronic device 106 to which the manager is currently logged into using their account. In some embodiments, the notification may be without the identification of the business entities that are associated with the observations. The notification may be based on different criteria described above for the operations of the flow diagram 400.

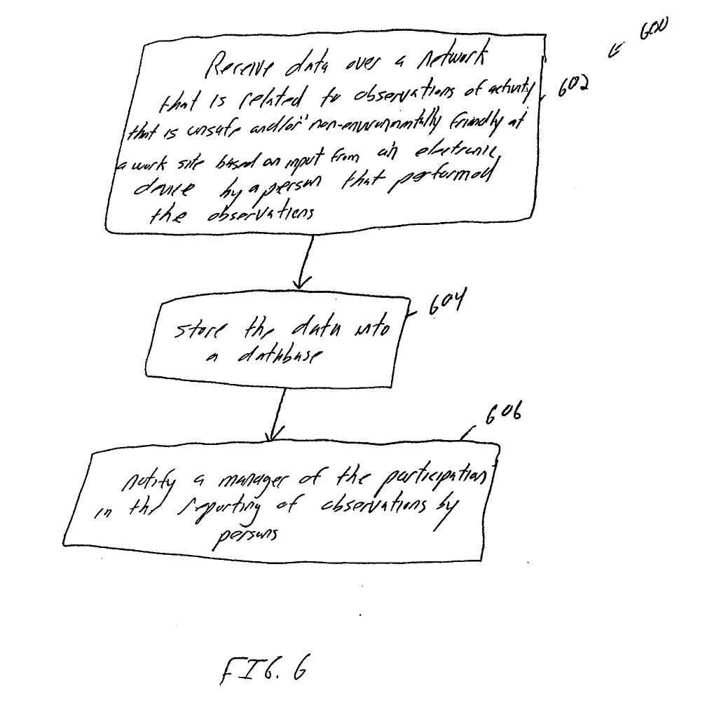

In some embodiments, persons (such as managers) may be notified based on the participation in the reporting of the observations. In particular, managers may be notified if the number of observations reported by a particular person is less than a threshold. The managers may also be notified if the number of observations reported is trending downward, etc. Such lack of reporting may be indicative of unsafe or non-environmentally friendly activity by such person. FIG. 6 illustrates a flow diagram for notifying a supervising party of the reporting of observations at work sites by persons, according to some embodiments of the invention.

In block 602, data is received over a network that is related to an observation of unsafe activity or an observation of activity that is non-environmentally friendly at a work site based on input from an electronic device) used by a person that performed the observation. With reference to the embodiments of FIGS. 1 and 3A, a person may input the data related to the observation into one of the electronic devices 106. The observation device logic 390 may receive and forward such data over the network interface 320 and through the network 102 to one of the servers 104. With reference to the embodiments of FIGS. 1 and 3B, the observation server logic 392 may receive the data over the network interface 320. Control continues at block 604.

In block 604, the data is stored in a database. With reference to the embodiment of FIG. 3B, the observation server logic 392 may store the database in one of the IDE/ATA drive(s) 308 (as described above). Control continues at block 606.

In block 606, a manager is notified of the participation in the reporting of observations by persons. With reference to the embodiments of FIGS. 1 and 3B, the observation server logic 392 may notify the manager. The observation server logic 392 may transmit a notification message through the network interface 320 and over the network 102 to the electronic device 106 to which the manager is currently logged into using their account. For example, the observation server logic 392 may notify a manager if the number of observations reported by a person is below a threshold for a time period. In some embodiments, the observation server logic 392 may notify a manager if the number of observations reported by a person is trending downward. For example, if the number of reported observations is dropping at least 10% for three consecutive months, a notification is transmitted.

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for notification transmission over a network based on observed data, in accordance with some embodiments of the invention. A number of figures show flow diagrams illustrating operations for notification transmission over a network based on observed data, in accordance with some embodiments of the invention. The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

1. An apparatus comprising:
a storage medium configured to store a database;
a port configured to receive, over a network, data related to a plurality of observations of activities at a work site that are either unsafe or environmentally unfriendly;
a processor operatively connected to the port and to the database; and
a machine-readable memory operably coupled to the processor, and bearing instructions that, when executed by the processor, perform operations comprising,
receiving a first data communication from the port, said first data communication comprising at least one observation of activity at a work site that is either unsafe or environmentally unfriendly;
storing said first data communication in the database;
receiving a second data communication from the port, said second data communication comprising at least one observation of activity at a work site that is either unsafe or environmentally unfriendly;
storing said second data communication in the database;
comparing at least one metric of at least one of the first data communication and the second data communication to at least one established criteria for reporting observations to a party; and
in the event that the at least one metric satisfies the criteria for reporting either or both observations of the first and second data communications, communicating a notification message to a party in accordance with the established criteria.

2. The apparatus of claim 1, wherein the party includes a manager of the work site.

3. (canceled)

4. The apparatus of claim 1, wherein at least one of the observations is of unsafe activity.

5. The apparatus of claim 4, wherein the at least one observation of unsafe activity includes an observation of at least one of: a reaction of a person, a lack of personal protective equipment, a position of a person, and activity related to a tool.

6. The apparatus of claim 1, wherein at least one of the observations is of non-environmentally friendly activity.

7. The apparatus of claim 6, at least one observation of non-environmentally friendly activity includes an observation of at least one of: an improper fill or transfer of a liquid or solid, an improper storage of a solid or liquid, an improper label of a product, a clean operation of a tool with an inappropriate product, an inappropriate product to clean a tool, and an inappropriate management of waste material.

8. The apparatus of claim 1, wherein the processor is configured to output the notification message based on a statistical analysis or a heuristic analysis of the data.

9. The apparatus of claim 1, wherein the criteria for communicating a notification message comprises prior or current activity by the supervising party.

10. The apparatus of claim 1, wherein the criteria for communicating a notification message is based at least in on a part on data the supervising party has previously reviewed.

11-12. (canceled)

13. The apparatus of claim 1, wherein the criteria for communicating a notification message comprises a consequence of the number of observations.

14. The apparatus of claim 1, wherein the criteria for communicating a notification message comprises a number of observations in a first geographic region and a consequence of the observations in the first geographic region.

15. The apparatus of claim 1, wherein the criteria for communicating a notification message is defined at least in part by a supervising party who will receive the message.

16. The apparatus of claim 1, wherein the criteria for communicating a notification message comprises a job role attribute of a supervising party who will receive the message.

17-54. (canceled)

55. A method of handling observations of worksite activity, comprising the acts of:
receiving a first data communication over a network, the first data communication comprising at least a first observation of activity at a work site that is either unsafe or environmentally unfriendly;
receiving a second data communication over a network, the second data communication comprising at least a second observation of activity at a work site that is either unsafe or environmentally unfriendly;
comparing at least one metric of at least one of the first data communication and the second data communication to at least one established criteria for reporting observations to a party; and
in the event that the at least one metric satisfies the criteria for reporting either or both observations of the first and second data communications, communicating a notification message to a party in accordance with the established criteria.

56. The method of claim 55, wherein the established criteria is selected from the group consisting of: the number of reported observations; the location of the observed activity, and a project associated with the observed activity.

57. The method of claim 55, wherein at least one criteria for reporting observations is user-configurable.

58. The method of claim 55, wherein observations are reported to multiple parties.

59. The method of claim 58, wherein the multiple parties comprises a supervising party.

60. The method of claim 59, wherein the supervising party is a supervisor of the worksite at which the observation occurred.

61. The method of claim 59, wherein the supervising party is a supervisor of a party involved in the observed activity.

62. The method of claim 55, further comprising the act of performing either a statistical analysis or a heuristic analysis of the observations.

63. The method of claim 55, further comprising the act of providing a user interface on a first electronic device for accepting input of at least said first data observations for communication across the network, and wherein the acts of receiving the first and second data communications are performed at a second electronic device.

64. The method of claim 55, further comprising the act of providing a user interface on an electronic device for reviewing received data observations.

65. Machine-readable storage media bearing instructions that when executed by one or more processors perform operations comprising:
receiving a first data communication, the first data communication comprising at least a first observation of activity at a work site that is either unsafe or environmentally unfriendly;
receiving a second data communication, the second data communication comprising at least a second observation of activity at a work site that is either unsafe or environmentally unfriendly;
comparing at least one metric of at least one of the first data communication and the second data communication to at least one established criteria for reporting observations to a party; and
in the event that the at least one metric satisfies the criteria for reporting either or both observations of the first and second data communications, communicating a notification message to a party in accordance with the established criteria.

66. The machine-readable storage media of claim 65, wherein the established criteria is selected from the group consisting essentially of: the number of reported observations; the location of the observed activity, and a project associated with the observed activity.

67. The machine-readable storage media of claim 65, wherein at least one criteria for reporting observations is user-configurable.
